(19) United States
(12) Patent Application Publication
(10) Pub. No.: US 2026/0139949 A1
(43) Pub. Date: May 21, 2026

(54) POSITIONING MEASUREMENT APPARATUS AND METHOD CAPABLE OF SENSOR EXPANSION FLEXIBLY BASED ON INVARIANT EXTENDED KALMAN FILTER (INEKF) AND POLYNOMIAL INTERPOLATION

(71) Applicant: ACEWORKS KOREA Inc., Seoul (KR)

(72) Inventors: Haeryong LIM, Seoul (KR); Sungjin CHO, Seoul (KR); Yohan KIM, Seoul (KR)

(21) Appl. No.: 19/386,628

(22) Filed: Nov. 12, 2025

(30) Foreign Application Priority Data
Nov. 18, 2024 (KR) 10-2024-0163750

(51) Int. Cl. G01C 21/20; G01C 21/16; G01C 23/00

(52) U.S. Cl. CPC G01C 21/20; G01C 21/16; G01C 23/00

(57) ABSTRACT

An embodiment relates to a positioning measurement apparatus and method capable of sensor expansion flexibly based on an invariant extended Kalman filter and polynomial interpolation. The positioning measurement apparatus applies a measurement value of a high real-time sensor among the multiple sensors to the invariant extended Kalman filter to continuously estimate a state of the vehicle in order to renews an OOSM problem that occurs when multiple sensors mounted on an autonomous vehicle are fused, and updates the state of the vehicle estimated by the invariant extended Kalman filter using measurement values of other sensors so as to solve the OOSM problem by reflecting and deskewing the delayed measurement values in the predicted state estimation values.

### CROSS-REFERENCE TO RELATED APPLICATION

This application is based on and claims priority under 35 U.S.C. § 119 to Korean Patent Application No. 10-2024-0163750, filed on Nov. 18, 2024, in the Korean Intellectual Property Office, the disclosures of which are incorporated by reference herein in its entirety.

### BACKGROUND OF THE INVENTION

### Field of the Invention

The present disclosure relates to a positioning measurement apparatus and method capable of sensor expansion flexibly based on an invariant extended Kalman filter (InEKF) and polynomial interpolation, which allows accurate positioning (three-dimensional position, rotation, velocity) by fusing various sensor data mounted on an autonomous vehicle to solve a time delay problem caused by multi-sensor fusion when measuring the positioning of a moving object.

This invention is a result of research on a project (Project No. RS-2023-00236825, Development of Urban Environment Management Service Technology Based on Autonomous Driving Lv. 4/4+) supported by the Ministry of Land, Infrastructure and Transport/Korea Agency for Infrastructure Technology Advancement.

### Background of the Related Art

An autonomous vehicle is a means of transportation that fuses automotive hardware and information and communication technology (ICT) to allow an automobile to perceive, determine, and control itself with the aim of eliminating and minimizing human intervention.

The autonomous vehicle is mounted with various sensors, and sensor data acquired from each sensor are fused to improve its performance through more accurate positioning measurements.

However, as a number of sensor types increases, there is a delay between the time the sensor data is measured by the sensor and the time it is input to an internal fusion processing apparatus due to different sensor output cycles (sensor characteristics) and different preprocessing processes of respective sensors. Therefore, sensor data is able to arrive at the fusion processing apparatus out of order rather than being input sequentially in terms of time. This situation is called an out-of-sequence environment, and sensor data input as out of sequence is called an out-of-sequence measurement (OOSM).

For example, in the case of an inertial measurement unit (IMU) sensor, there is almost no delay, but in the case of GPS, there is a delay of about 0.1 seconds, so even though the sensor data is measured at the same time, data from the IMU sensor is able to be input first and then data from the GPS is able to be input.

The simplest solution to the OOSM problem is to store data for a maximum delay (e.g., about 0.5 seconds) of the sensor and perform an updates after that time has elapsed. However, in this case, there is a problem of poor real-time performance because the state of the past is always measured for 0.5 seconds.

Related prior art literature includes Korean Patent Publication No. 10-2021-0056589 (Title of invention: Sensor synchronization method and apparatus for autonomous driving sensor fusion, Publication date: May 20, 2021) This proposes a synchronization process of estimating time delays of various sensors using the Extended Kalman Filter (EKF) and compensating for the estimated time delays. That is, this prior art literature is an invention that presents a method for compensating for time delays for the purpose of synchronization between multiple sensors. In addition, the extended Kalman filter disclosed in this prior art literature has a problem of reduced positioning accuracy because it separately manages the position, velocity, and rotation of a moving object.

### CITATION LIST

### Patent Literature

(Patent Document 1) Korean Patent Publication No. 10-2021-0056589 (Publication date: May 20, 2021)

### SUMMARY OF THE INVENTION

An aspect of the present disclosure is to provide a positioning measurement apparatus and method capable of sensor expansion flexibly based on an invariant extended Kalman filter (InEKF) and polynomial interpolation, which, in order to renew an OOSM problem that occurs when multiple sensors are fused rather than for the purpose of synchronization between multiple sensors mounted on an autonomous vehicle, applies a measurement value of a high real-time sensor among the multiple sensors to the invariant extended Kalman filter to continuously estimate a state of the vehicle, and updates the state of the vehicle estimated by the invariant extended Kalman filter using measurement values of other sensors so as to solve the OOSM problem by reflecting and deskewing the delayed measurement values in the predicted state estimation values.

In order to achieve the foregoing objectives, a positioning measurement apparatus capable of sensor expansion flexibly based on an invariant extended Kalman filter and polynomial interpolation according to an embodiment of the present disclosure includes a state estimation unit that estimates a three-dimensional state of a moving object by applying sensor data measured from an inertial measurement unit (IMU) sensor to an invariant extended Kalman filter (InEKF); a polynomial interpolation unit that calculates a state estimation value generated through the state estimation unit in a form of a continuous function over time using a polynomial interpolation method; a matching unit that matches, when a measurement value is input from at least one other sensor of a different type than the IMU sensor, a measurement value of the other sensor with a state estimation value based on a time at which the measurement value of the other sensor was measured in the continuous function calculated by the polynomial interpolation unit; and a state update unit that calculates a residual between a measurement value of the other sensor and a state estimation value and computes a Jacobian for the state estimation value to update the state estimation value using the residual and the computed Jacobian value.

In this case, the three-dimensional state is pose data including a three-dimensional position, a three-dimensional velocity, and a three-dimensional rotation, and the state estimation unit predicts a three-dimensional state using IMU sensor data input within a set period of time and deletes, when new sensor data is input, sensor data in an order in which it was input in the past.

In addition, a positioning measurement apparatus capable of sensor expansion flexibly based on an invariant extended Kalman filter and polynomial interpolation according to an embodiment of the present disclosure is able to include a validity determination unit that determines, when a measurement value is input from the at least one other sensor, a validity of data based on whether a measurement time of the measurement value falls within minimum and maximum times of a state estimation value calculated through the polynomial interpolation unit.

In addition, the polynomial interpolation unit derives and applies a polynomial interpolation formula for an extended special Euclidean group SE₂(3) as in Equation 1 below in order to apply a state estimation value estimated through the invariant extended Kalman filter.

$${T}_{B}^{W} ( t ) = {T}_{B , 0}^{W} Exp ( \text{?} {( t - {t}_{0} )}^{i} ) \qquad [ Equation 1 ]$$

$$where ( \begin{matrix}{a}_{1} \\ {a}_{2} \\ … \\ \text{?}\end{matrix} ) = {V}^{- 1} Δ T = {( \begin{matrix}( {t}_{1} - {t}_{0} ) \text{?} & ( {t}_{1} - {t}_{0} \text{?} & … & ( {t}_{1} - {t}_{0} \text{?} \\ ( {t}_{2} - {t}_{0} ) \text{?} & ( {t}_{2} - {t}_{0} \text{?} & … & ( {t}_{2} - {t}_{0} \text{?} \\ … & … & … & … \\ ( \text{?} - {t}_{0} ) \text{?} & ( \text{?} - {t}_{0} \text{?} & … & ( \text{?} - {t}_{0} \text{?}\end{matrix} )}^{- 1} ( \begin{matrix}Log ( \text{?} {T}_{B , 1}^{W} ) \\ Log ( \text{?} {T}_{B , 2}^{W} ) \\ … \\ Log ( \text{?} )\end{matrix} )$$

$$\text{?} \text{indicates text missing or illegible when filed}$$

In addition, the status update unit is able to calculate the residual using Equation 2 below.

$$residual z = Y ⊖ h ( {T}_{B}^{W} ( t ) ) \qquad [ Equation 2 ]$$

$$where h ( ) : observation model$$

$$Y : sensor measurement$$

In addition, the Jacobian computation is obtained by using Equation 3 below to linearly approximate a state estimation value, which is the continuous function value, using a differential method.

$$[ Equation 3 ]$$

$${\frac{\partial {T}_{B}^{W} ( t )}{\partial {T}_{B , 0}^{W}} = - {J}_{r} ( Exp ( {\sum }_{i = 1}^{n} {{a}_{i} ( t - {t}_{0} )}^{i} ) ) m ( t ) {V}^{- 1} ( \begin{matrix}\text{?} ( \text{?} {T}_{B , 1}^{W} ) \\ \text{?} ( \text{?} {T}_{B , 2}^{W} ) \\ … \\ \text{?} ( \text{?} )\end{matrix} ) + Adj ( Exp ( {\sum }_{i = 1}^{n} {{a}_{i} ( t - {t}_{0} )}^{i} ) ) )}^{- 1}$$

$$\frac{\partial {T}_{B}^{W} ( t )}{\partial {T}_{B , k}^{W}} = - {J}_{r} ( Exp ( {\sum }_{i = 1}^{n} {{a}_{i} ( t - {t}_{0} )}^{i} ) ) m ( t ) {V}^{- 1} ( \begin{matrix}0 \\ … \\ - \text{?} ( \text{?} {T}_{B , k}^{W} ) \\ … \\ 0\end{matrix} )$$

$$( k = 1 , 2 , 3 , ... , n )$$

$$where m ( t ) = ( \begin{matrix}( t - {t}_{0} ) \text{?} & {( t - {t}_{0} )}^{2} \text{?} & … & {( t - {t}_{0} )}^{n} \text{?}\end{matrix} )$$

$$\text{?} \text{indicates text missing or illegible when filed}$$

Meanwhile, a positioning measurement method capable of sensor expansion flexibly based on an invariant extended Kalman filter and polynomial interpolation according to an embodiment of the present disclosure includes applying, by the positioning measurement apparatus, sensor data measured from an inertial measurement unit (IMU) sensor to an invariant extended Kalman filter (InEKF) to estimate a three-dimensional state of a moving object; calculating, by the positioning measurement apparatus, a state estimation value generated through the estimating of a three-dimensional state in a form of a continuous function over time using a polynomial interpolation method; matching, by the positioning measurement apparatus, when a measurement value is input from at least one other sensor of a different type than the IMU sensor, a measurement value of the other sensor with a state estimation value based on a time at which the measurement value of the other sensor was measured in the continuous function calculated by the polynomial interpolation method; calculating, by the positioning measurement apparatus, a residual between a measurement value of the other sensor and a state estimation value matched based on the measurement time; computing, by the positioning measurement apparatus, a Jacobian for the state estimation value; and updating, by the positioning measurement apparatus, the state estimation value using the residual and the computed Jacobian value.

According to the present disclosure, a state is predicted from a measurement value measured through one reference sensor, and the predicted state estimation value is compared and analyzed with a delayed measurement value of another sensor to deskew a state estimation value by a residual between the state estimation value and the measurement value to update a current state so as to minimize a error of the state estimation value, thereby providing a remarkable effect capable of increasing the accuracy of positioning technology.

In addition, according to the present disclosure, an OOSM problem that occurs when multiple sensors are fused has been solved, and various sensors are able to be freely added without modifying an algorithm to estimate the position of an autonomous vehicle, thereby having an effect capable of sensor expansion flexibly.

### BRIEF DESCRIPTION OF THE DRAWINGS

FIG. 1 is a conceptual diagram for explaining an out-of-sequence measurement (OOSM) phenomenon.

FIG. 2 is a block diagram showing a positioning measurement apparatus capable of sensor expansion flexibly based on an invariant extended Kalman filter and polynomial interpolation according to an embodiment of the present disclosure.

FIG. 3 is a configuration diagram showing a pre-operation unit of a sensor in the positioning measurement apparatus of FIG. 2.

FIGS. 4 to 7 are graphs showing a function of each component included in the positioning measurement apparatus of FIG. 2.

FIG. 8 is an operational flowchart showing a positioning measurement method capable of sensor expansion flexibly based on an invariant extended Kalman filter and polynomial interpolation according to an embodiment of the present disclosure.

### DETAILED DESCRIPTION OF THE PREFERRED EMBODIMENT

In order to fully understand the present disclosure, operational advantages thereof and objects achieved by embodiments of the present disclosure, it is necessary to refer to the accompanying drawings illustrating a preferred embodiment of the present disclosure and the contents described in the accompanying drawings.

Hereinafter, preferred embodiments of the present disclosure will be described in detail with reference to the accompanying drawings. However, in describing the present disclosure, a description of a function or configuration already known will be omitted in order to clarify the subject matter of the present disclosure.

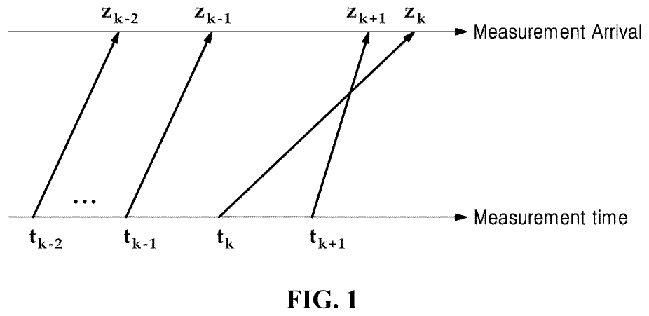

FIG. 1 is a conceptual diagram for explaining an OOSM phenomenon.

The out-of-sequence measurement (OOSM) occurs, when measurement values acquired from respective sensors in a multi-sensor-multi-target environment are transmitted to a fusion processing apparatus, due to transmission delays between the sensors and the fusion processing unit, different preprocessing processes of the respective sensors performed to transmit the measurement values, and the like. As can be seen from FIG. 1, measurement values Zₖ₋₂, Zₖ₋₁, Zₖ₊₁ respectively measured at measurement times tₖ₋₂, tₖ₋₁, tₖ₊₁ go through a preprocessing process and come in an order of the measurement times after a certain period of time, and a phenomenon occurred in which a measurement value Zₖ measured at tₖ was transmitted to the fusion processing apparatus with a delay greater than the measurement value Zₖ₊₁ measured at tₖ₊₁. In this way, measurement values that arrive delayed with the order of input changed to the fusion processing apparatus or internal processing filter are called OOSM, as distinguished from measurement values that are input sequentially.

When a delay time of OOSM is relatively long, a result of ignoring this measurement value and performing a general filter renewal process does not differ significantly in the performance of the filter compared to the case where OOSM is considered. However, when the delay time is short or OOSM occurs continuously, an error in the predicted state estimation value is large, so it is necessary to include OOSM in the filter renewal process.

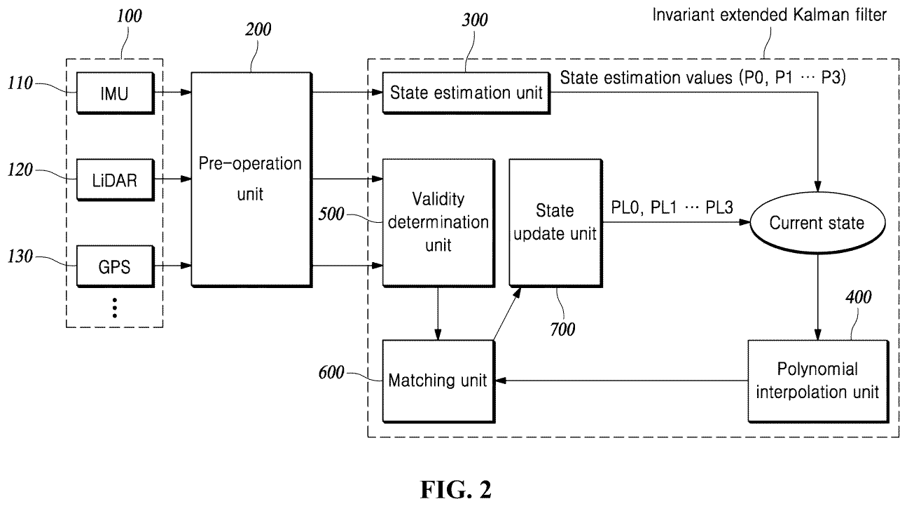

A specific configuration therefor is as shown in FIG. 2.

FIG. 2 is a block diagram showing a positioning measurement apparatus capable of sensor expansion flexibly based on an invariant extended Kalman filter and polynomial interpolation according to an embodiment of the present disclosure.

A positioning measurement apparatus according to an embodiment of the present disclosure basically performs a motion based on an invariant extended Kalman filter (InEKF).

The invariant extended Kalman filter is a reconstruction of the Kalman filter theory by generalizing it to a Li group, consisting of two processes: state prediction and state update. In the prediction process, the value and accuracy (covariance matrix) of a current state variable are predicted. In the update process, a state variable is updated by reflecting a residual, which is a difference between a predicted estimation value based on a previously estimated state variable value and an actual measurement value.

If a Kalman filter is a recursive filter that estimates a state of a linear dynamic system, an extended Kalman filter and an invariant extended Kalman filter are algorithms that estimate a state of a nonlinear dynamic system. That is, it is able to be said to be effective in estimating a three-dimensional pose of a dynamic moving object. The invariant extended Kalman filter is able to improve the convergence of a state estimation value by the extended Kalman filter, but the extended Kalman filter has a disadvantage of lowering positioning accuracy by separately managing the position, velocity, and rotation of a moving object.

Therefore, the positioning measurement apparatus according to an embodiment of the present disclosure uses an invariant extended Kalman filter for positioning accuracy, and includes a state estimation unit 300, a polynomial interpolation unit 400, a validity determination unit 500, a matching unit 600, and a state update unit 700 to process data.

In this case, in an embodiment of the present disclosure, in the multi-sensor 100, an inertial measurement unit (IMU) sensor 110 with high real-time performance, that is, the fastest data cycle (e.g., 100 Hz) is used as reference sensor data, and at least one other sensor 120, 130 other than the IMU sensor 110 is able to be flexibly added and applied. Here, it is assumed that the other sensors 120, 130 are sensor with a slower update cycle and a time delay than the IMU sensor 110, and if they are of a type corresponding thereto, they are able to be expanded and applied in various ways. For example, FIG. 1 illustrates a LiDAR sensor 120 and a GPS sensor 130 as other sensors, but other sensors such as a camera sensor and a wheel speed sensor are able to also be included. Since the multiple sensors 100 respectively have different update cycles and time delays, initial characteristics are able to be measured and set to initial values, respectively.

A pre-operation unit 200 performs an operation to convert sensor data of each sensor 110, 120, 130 included in the multi-sensor 100 into a signal that is easy to analyze a three-dimensional position or pose. The pre-operation unit 200 performs different operation processing for each sensor 110, 120, 130.

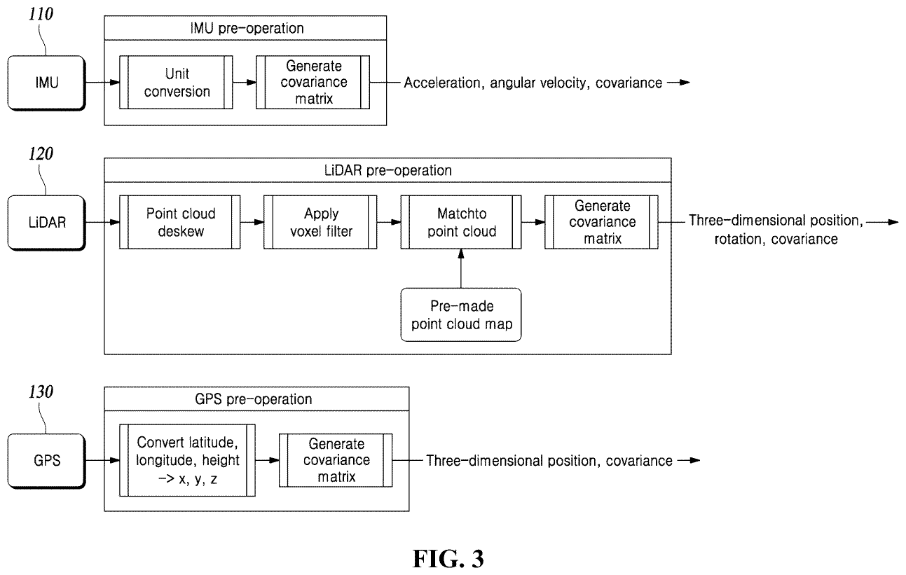

FIG. 3 is a configuration diagram showing a pre-operation unit of a sensor in the positioning measurement apparatus of FIG. 2.

The IMU sensor 110 performs unit conversion and covariance matrix operations to output acceleration, angular velocity, and covariance.

The LiDAR sensor 120 outputs a three-dimensional position, rotation, and covariance through pre-processing processes such as operation processing for deskewing a slope of a point cloud, operation processing for projecting it into a three-dimensional space by applying a voxel filter and matching it to a point cloud map, and covariance matrix operation processing.

The GPS sensor 130 outputs a three-dimensional position and covariance through an operation process that converts latitude, longitude, and height data into X, Y, and Z coordinates and a covariance matrix operation process.

The sensor data pre-operated in this way is input to the state estimation unit 300 or the validity determination unit 500 to measure the positioning of a moving object, that is, a three-dimensional state (three-dimensional position, speed, rotation) (also called a ‘pose’).

Referring again to FIG. 2, the state estimation unit 300 receives sensor data measured from the IMU sensor 110 and applies it to an invariant extended Kalman filter to estimate the state of a moving object.

State values used in an operation of the invariant extended Kalman filter are as follows.

$$State χ = \{ {b}_{g} , {b}_{a} , {T}_{B , 0}^{W} , {T}_{B , 1}^{W} , … , {T}_{B , n}^{W} \}$$

b_{g} is a three-dimensional vector referring to a bias value of an angular velocity value measured by a gyroscope in the IMU sensor. When an angular velocity value is input from the IMU sensor, the corresponding value is subtracted from the angular velocity value and a value from which the bias has been removed is used for state prediction.
bₐ is a three-dimensional vector referring to a bias value of an acceleration value measured by an accelerometer in the IMU sensor. When an acceleration value is input from the IMU sensor, the corresponding value is subtracted from the acceleration value and a value from which the bias has been removed is used for state prediction.

$${T}_{B}^{W}$$

is a Lie group SE₂(3) representing a pose (a three-dimensional position+a three-dimensional velocity+a three-dimensional rotation) of an object. The superscript W, which stands for World, refers to an arbitrary fixed reference point, and the subscript B, which stands for body, refers to an object (more precisely, an IMU sensor). Therefore, this denotes a relative pose of the IMU sensor with respect to W.

$${T}_{B , 0}^{W}$$

refers to a pose of the IMU sensor at time t₀. In order to apply polynomial interpolation, two or more poses for different times are required. Therefore, a current state has two or more poses, and there is a motion to delete an old pose and add a new pose at regular cycles.

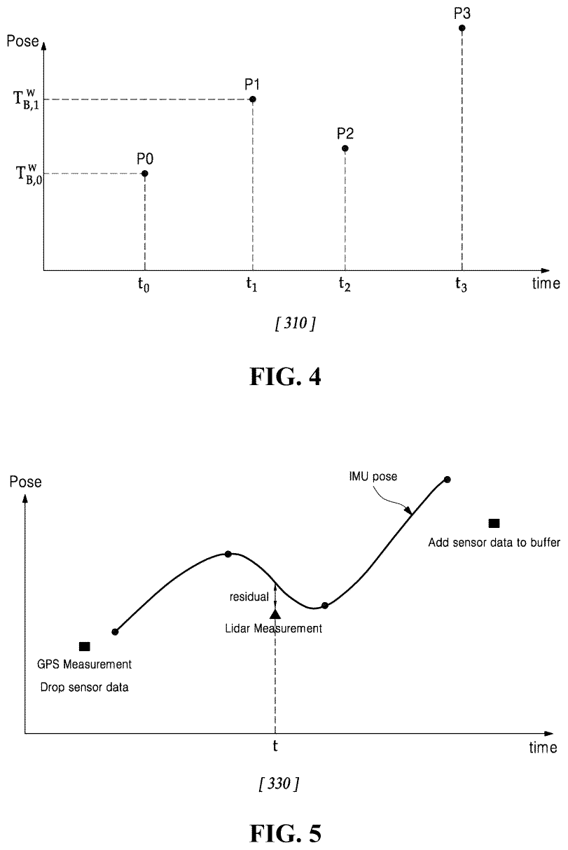

The pose of the IMU sensor output through the state estimation unit 300 is estimated as linear values (points) such as P0, P1, P2, and P3 as illustrated in FIG. 4. The pose of an object is able to be predicted using the position, acceleration, and angular velocity at each point.

A state estimation value of the IMU sensor output through the state estimation unit 300 becomes a current state value while a measurement value of another sensor is not input.

In this case, the state estimation unit 300 predicts a three-dimensional state using IMU sensor data input within a set period of time and deletes, when new sensor data is input, sensor data in an order in which it was input in the past.

The polynomial interpolation unit 400 calculates a state estimation value generated by the state estimation unit 300 in a form of a continuous function over time using polynomial interpolation. FIG. 5 shows a continuous function calculated through polynomial interpolation for P0, P1, P2, and P3 in FIG. 4.

In order to apply a state estimation value estimated through an invariant extended Kalman filter, the polynomial interpolation unit 400 in the present disclosure derives and applies a polynomial interpolation formula for the extended special Euclidean group SE₂(3).

The polynomial interpolation formula is able to be expressed by Equation below.

$${T}_{B}^{W} ( t ) = {T}_{B , 0}^{W} Exp ( {\sum }_{i = 1}^{n} {{a}_{i} ( t - {t}_{0} )}^{i} )$$

$$where ( \begin{matrix}{a}_{1} \\ {a}_{2} \\ … \\ \text{?}\end{matrix} ) = {V}^{- 1} Δ T = {( \begin{matrix}( {t}_{1} - {t}_{0} ) \text{?} & ( {t}_{1} - {t}_{0} \text{?} & … & ( {t}_{1} - {t}_{0} \text{?} \\ ( {t}_{2} - {t}_{0} ) \text{?} & ( {t}_{2} - {t}_{0} \text{?} & … & ( {t}_{2} - {t}_{0} \text{?} \\ … & … & … & … \\ ( \text{?} - {t}_{0} ) \text{?} & ( \text{?} - {t}_{0} \text{?} & … & ( \text{?} - {t}_{0} \text{?}\end{matrix} )}^{- 1} ( \begin{matrix}Log ( \text{?} {T}_{B , 1}^{W} ) \\ Log ( \text{?} {T}_{B , 2}^{W} ) \\ … \\ Log ( \text{?} )\end{matrix} )$$

$$\text{?} \text{indicates text missing or illegible when filed}$$

(Here,

$${T}_{B}^{W}$$

is a Lie group SE₂(3) representing a pose (three-dimensional position+rotation+velocity) of an object, a superscript W, which is an abbreviation for World, refers to an arbitrary fixed reference point, and B, which is an abbreviation for Body, refers to an object (more precisely, an IMU sensor). Therefore,

$${T}_{B}^{W}$$

refers to a relative pose (state) of the IMU based on W.

$${T}_{B , 0}^{W}$$

is a pose value of the IMU at time t₀, aᵢ∈ [symbol] is a coefficient used for polynomial interpolation, and V and ΔT are temporary values used in a process of computing it.)

The validity determination unit 500 receives a measurement value from at least one other sensor 120, 130 and determines a validity of data based on whether a measurement time of the received measurement value falls within minimum and maximum times of a state estimation value estimated through the polynomial interpolation unit 400.

Here, the minimum and maximum times of the state estimation value estimated through the polynomial interpolation unit 400 are related to prediction using IMU sensor data input within a set period of time in the state estimation unit 300, and in this case, the beginning and end of the set period of time become the minimum and maximum times.

As an example, referring to FIG. 5, a function shown in FIG. 5 is a continuous function estimated through the polynomial interpolation unit 400 for state estimation values P0, P1, P2, P3 generated from the state estimation unit 300. Based thereon, it is determined whether the measurement values of other sensors fall between minimum and maximum times of an IMU state estimation value function.

Only the measurement values that fall between the minimum and maximum times of the IMU state estimation value function are input to an invariant extended Kalman filter. Measurement values that fall before the minimum time are discarded because they fall outside a coverage range of polynomial interpolation, and for measurement values that fall after the maximum time, data are stored in a buffer and wait to be input to the invariant extended Kalman filter when new IMU sensor data comes in and comes within the maximum time of the IMU state estimation value.

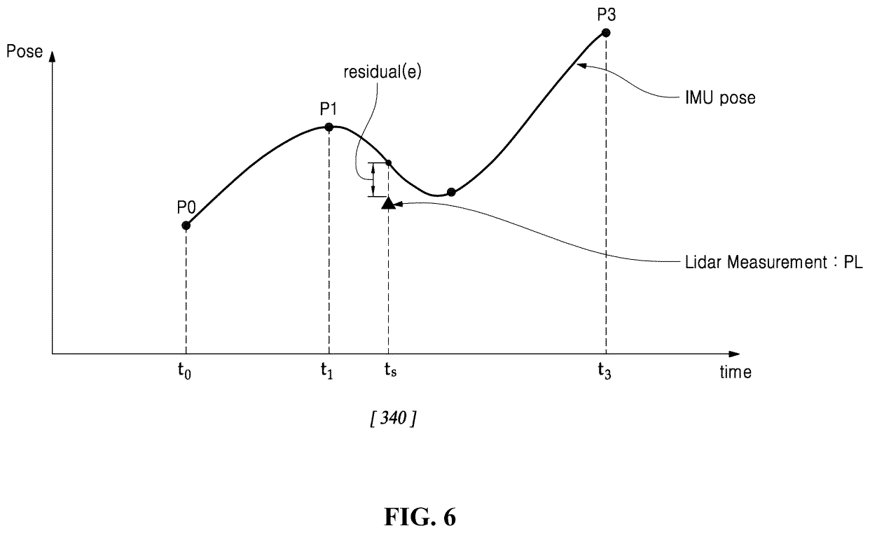

The matching unit 600 filters the measurement values input from at least one other sensor 120, 130 through the validity determination unit 500, and then matches the incoming measurement values with a continuous function calculated by the polynomial interpolation unit 400. In this case, since the measurement value includes a measurement time measured by the sensor, the state estimation value matching the measurement time is able to be confirmed from a continuous function based on this measurement time. In this regard, FIG. 6 shows an example of matching an IMU state estimation value with a measurement value based on a measurement time (t) of the measurement value of the LiDAR sensor.

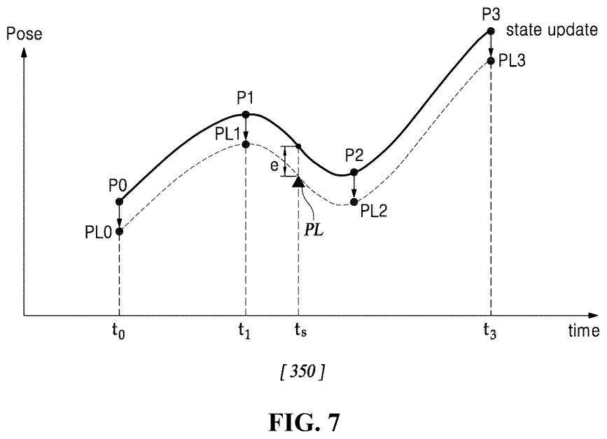

The status update unit 700 calculates a residual e between a measurement value of another sensor and an IMU state estimation value, and computes a Jacobian for a state estimation value calculated through polynomial interpolation. Furthermore, when the state estimation value is updated using the calculated residual e and the computed Jacobian value, the past state estimation values P0, P1, P2, P3 are newly updated to PL0, PL1, PL2, PL3 as shown in FIG. 7.

The residual e is able to be calculated using Equation below.

$$residual z = Y ⊖ h ( {T}_{B}^{W} ( t ) )$$

$$where h ( ) : observation model$$

$$Y : sensor measurement$$

The Jacobian computation is able to be obtained using Equation below to linearly approximate a state estimation value, which is a continuous function value, using a differential method.

$${\frac{\partial {T}_{B}^{W} ( t )}{\partial {T}_{B , 0}^{W}} = - {J}_{r} ( Exp ( {\sum }_{i = 1}^{n} {{a}_{i} ( t - {t}_{0} )}^{i} ) ) m ( t ) {V}^{- 1} ( \begin{matrix}\text{?} ( \text{?} {T}_{B , 1}^{W} ) \\ \text{?} ( \text{?} {T}_{B , 2}^{W} ) \\ … \\ \text{?} ( \text{?} )\end{matrix} ) + \\ Adj ( Exp ( {\sum }_{i = 1}^{n} {{a}_{i} ( t - {t}_{0} )}^{i} ) ) )}^{- 1}$$

$$\frac{\partial {T}_{B}^{W} ( t )}{\partial {T}_{B , k}^{W}} = - {J}_{r} ( Exp ( {\sum }_{i = 1}^{n} {{a}_{i} ( t - {t}_{0} )}^{i} ) ) m ( t ) {V}^{- 1} ( \begin{matrix}0 \\ … \\ - \text{?} ( \text{?} {T}_{B , k}^{W} ) \\ … \\ 0\end{matrix} )$$

$$( k = 1 , 2 , 3 , ... , n )$$

$$where m ( t ) = ( \begin{matrix}( t - {t}_{0} ) \text{?} & {( t - {t}_{0} )}^{2} \text{?} & … & ( t - {t}_{0} \text{?}\end{matrix} )$$

$$\text{?} \text{indicates text missing or illegible when filed}$$

Accordingly, in order to renew an OOSM problem that occurs when multiple sensors are fused, the positioning measurement apparatus of the present disclosure configured as described above applies sensor data of an IMU sensor among multiple sensors to an invariant extended Kalman filter to continuously estimate a state of a vehicle, and updates the state of the vehicle estimated by the invariant extended Kalman filter using measurement values of other sensors, thereby solving the OOSM problem by a method of reflecting and deskewing the delayed measurement values in the predicted state estimation values.

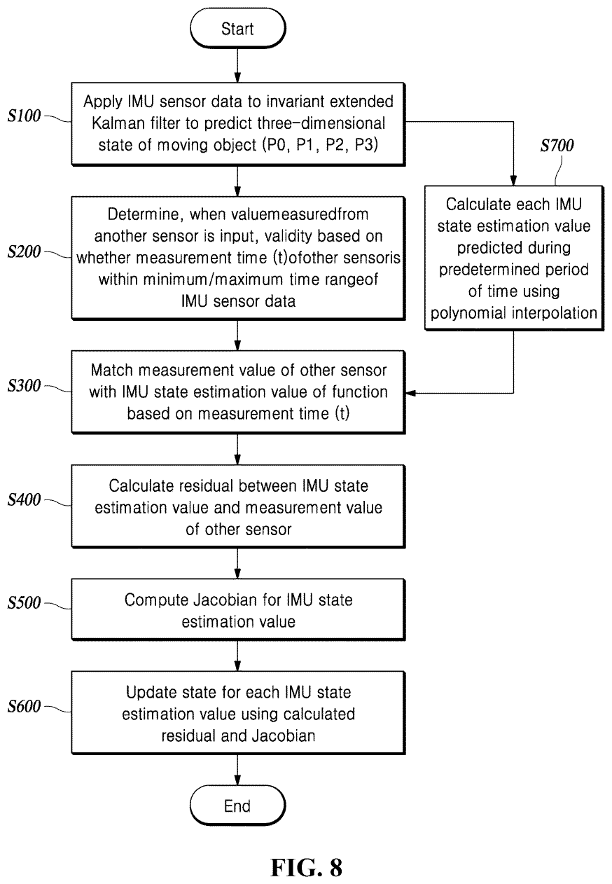

Then, a method of measuring positioning based on an invariant extended Kalman filter and polynomial interpolation will be described with reference to the foregoing configuration of the positioning measurement apparatus and FIG. 8.

In an embodiment of the present disclosure, it is assumed that sensor data measured from multiple sensors is pre-operated and input to a positioning measurement apparatus.

In a first step, the positioning measurement apparatus inputs sensor data measured from an IMU sensor among multiple sensors into an invariant extended Kalman filter (InEKF) in a state estimation unit to predict a three-dimensional state of a dynamic object (S100). As a result of the prediction, state estimation values (P0, P1, P2, and P3 in FIG. 4) for the sensor data input within a set section are generated.

Next, the positioning measurement apparatus calculates a state estimation value generated through a previous step in a form of a continuous function over time using polynomial interpolation in a polynomial interpolation unit (S700). This step is to estimate a state estimation value corresponding to a measurement time of a measurement value in order to compute a residual between the state estimation value and the measurement value to be described later.

Next, the positioning device determines, when a measurement value is input from at least one other sensor of a different type than an IMU sensor, a validity of data in a validity determination unit by analyzing whether a measurement time (t in FIGS. 5, 6, and 7) of the corresponding measurement value is within a cover range of polynomial interpolation (S200).

Next, the positioning measurement apparatus matches the measurement values of other sensors with a continuous function calculated by polynomial interpolation in the matching unit based on the measurement time (t in FIGS. 5, 6, and 7) of the measurement value (S300).

Next, the positioning measurement apparatus calculates a residual between the measurement value and the state estimation value matched based on the measurement time in a status update unit (S400).

Next, the positioning measurement apparatus computes a Jacobian for the state estimation value calculated through polynomial interpolation in the state update unit (S500).

Next, the positioning measurement apparatus updates the existing state estimation value to a new state using the residual and the computed Jacobian value (S600).

A specific description of each step is the same as that described above in the description of the apparatus, and thus a redundant description thereof will be omitted.

Although the present disclosure has been described in detail through preferred embodiments thereof, it is obvious to those skilled in the art that the present disclosure is not limited to the above-described preferred embodiments, and that various modifications and variations is able to be made without departing from the concept and scope of the present disclosure. Therefore, such modifications and variations should fall within the scope of the claims of the present disclosure.

### DESCRIPTION OF SYMBOLS

| | |
|---|---|
| 100: Multi-sensor | 110: IMU sensor |
| 120: LiDAR sensor | 130: GPS sensor |
| 200: Pre-operation unit | 300: State estimation unit |
| 400: Polynomial interpolation unit | |
| 500: Validity determination unit | |
| 600: Matching unit | 700: State update unit |

What is claimed is:

1. A positioning measurement apparatus capable of sensor expansion flexibly based on an invariant extended Kalman filter and polynomial interpolation, the apparatus comprising:
a state estimation unit that estimates a three-dimensional state of a moving object by applying sensor data measured from an inertial measurement unit (IMU) sensor to an invariant extended Kalman filter (InEKF);
a polynomial interpolation unit that calculates a state estimation value generated through the state estimation unit in a form of a continuous function over time using a polynomial interpolation method;
a matching unit that matches, when a measurement value is input from at least one other sensor of a different type than the IMU sensor, a measurement value of the other sensor with a state estimation value based on a time at which the measurement value of the other sensor was measured in the continuous function calculated by the polynomial interpolation unit; and
a state update unit that calculates a residual between a measurement value of the other sensor and a state estimation value and computes a Jacobian for the state estimation value to update the state estimation value using the residual and the computed Jacobian value.

2. The apparatus of claim 1, wherein the three-dimensional state is pose data including a three-dimensional position, a three-dimensional velocity, and a three-dimensional rotation, and
wherein the state estimation unit predicts a three-dimensional state using IMU sensor data input within a set period of time and deletes, when new sensor data is input, sensor data in an order in which it was input in the past.

3. The apparatus of claim 1, further comprising:
a validity determination unit that determines, when a measurement value is input from the at least one other sensor, a validity of data based on whether a measurement time of the measurement value falls within minimum and maximum times of a state estimation value calculated through the polynomial interpolation unit.

4. The apparatus of claim 1, wherein the polynomial interpolation unit derives and applies a polynomial interpolation formula for an extended special Euclidean group SE₂(3) as in Equation 1 below in order to apply a state estimation value estimated through the invariant extended Kalman filter.
$${T}_{B}^{W} ( t ) = {T}_{B , 0}^{W} Exp ( {\sum }_{i = 1}^{n} {a}_{i} ( t - {t}_{0} \text{?} \qquad [ Equation 1 ]$$
$$where ( \begin{matrix}{a}_{1} \\ {a}_{2} \\ … \\ \text{?}\end{matrix} ) = {V}^{- 1} Δ T = {( \begin{matrix}( {t}_{1} - {t}_{0} ) \text{?} & ( {t}_{1} - {t}_{0} \text{?} & … & ( {t}_{1} - {t}_{0} \text{?} \\ ( {t}_{2} - {t}_{0} ) \text{?} & ( {t}_{2} - {t}_{0} \text{?} & … & ( {t}_{2} - {t}_{0} \text{?} \\ … & … & … & … \\ ( \text{?} - {t}_{0} ) \text{?} & ( \text{?} - {t}_{0} \text{?} & … & ( \text{?} - {t}_{0} \text{?}\end{matrix} )}^{- 1} ( \begin{matrix}Log ( \text{?} {T}_{B , 1}^{W} ) \\ Log ( \text{?} {T}_{B , 2}^{W} ) \\ … \\ Log ( \text{?} )\end{matrix} )$$
$$\text{?} \text{indicates text missing or illegible when filed}$$
(Here,
$${T}_{B}^{W}$$
is a Lie group SE₂(3) representing a pose (three-dimensional position+rotation+velocity) of an object, a superscript W, which is an abbreviation for World, refers to an arbitrary fixed reference point, and B, which is an abbreviation for Body, refers to an object (more precisely, an IMU sensor). Therefore,
$${T}_{B}^{W}$$
refers to a relative pose (state) of the IMU based on W.
$${T}_{B , 0}^{W}$$
is a pose value of the IMU at time t₀, aᵢ∈ [symbol] is a coefficient used for polynomial interpolation, and V and ΔT are temporary values used in a process of computing it.)

5. The apparatus of claim 1, wherein the status update unit calculates the residual using Equation 2 below.
$$residual z = Y ⊖ h ( {T}_{B}^{W} ( t ) ) \qquad [ Equation 2 ]$$
$$where h ( ) : observation model$$
$$Y : sensor measurement$$

6. The apparatus of claim 1, wherein the Jacobian computation uses Equation 3 below to linearly approximate a state estimation value, which is the continuous function value, using a differential method.
$$[ Equation 3 ]$$
$${\frac{\partial {T}_{B}^{W} ( t )}{\partial {T}_{B , 0}^{W}} = - {J}_{r} ( Exp ( {\sum }_{i = 1}^{n} {{a}_{i} ( t - {t}_{0} )}^{i} ) ) m ( t ) {V}^{- 1} ( \begin{matrix}\text{?} ( \text{?} {T}_{B , 1}^{W} ) \\ \text{?} ( \text{?} {T}_{B , 2}^{W} ) \\ … \\ \text{?} ( \text{?} )\end{matrix} ) + Adj ( Exp ( {\sum }_{i = 1}^{n} {{a}_{i} ( t - {t}_{0} )}^{i} ) ) )}^{- 1}$$
$$\frac{\partial {T}_{B}^{W} ( t )}{\partial {T}_{B , k}^{W}} = - {J}_{r} ( Exp ( {\sum }_{i = 1}^{n} {{a}_{i} ( t - {t}_{0} )}^{i} ) ) m ( t ) {V}^{- 1} ( \begin{matrix}0 \\ … \\ - \text{?} ( \text{?} {T}_{B , k}^{W} ) \\ … \\ 0\end{matrix} )$$
$$( k = 1 , 2 , 3 , ... , n )$$
$$where m ( t ) = ( \begin{matrix}( t - {t}_{0} ) \text{?} & {( t - {t}_{0} )}^{2} \text{?} & … & ( t - {t}_{0} \text{?}\end{matrix} )$$
$$\text{?} \text{indicates text missing or illegible when filed}$$

7. A method in a positioning measurement apparatus capable of sensor expansion flexibly based on an invariant extended Kalman filter and polynomial interpolation, the method comprising:
applying, by the positioning measurement apparatus, sensor data measured from an inertial measurement unit (IMU) sensor to an invariant extended Kalman filter (InEKF) to estimate a three-dimensional state of a moving object;
calculating, by the positioning measurement apparatus, a state estimation value generated through the estimating of a three-dimensional state in a form of a continuous function over time using a polynomial interpolation method;
matching, by the positioning measurement apparatus, when a measurement value is input from at least one other sensor of a different type than the IMU sensor, a measurement value of the other sensor with a state estimation value based on a time at which the measurement value of the other sensor was measured in the continuous function calculated by the polynomial interpolation method;
calculating, by the positioning measurement apparatus, a residual between a measurement value of the other sensor and a state estimation value matched based on the measurement time;
computing, by the positioning measurement apparatus, a Jacobian for the state estimation value; and
updating, by the positioning measurement apparatus, the state estimation value using the residual and the computed Jacobian value.
